(19) United States
(12) Patent Application Publication
(10) Pub. No.: US 2006/0261305 A1
(43) Pub. Date: Nov. 23, 2006

(54) Snow melting composition

(75) Inventors: Hirokazu Ohike, Hyogo (JP); Hiroshi Hattori, Hyogo (JP); Hideki Kawamoto, Hyogo (JP); Noriko Fujio, Hyogo (JP); Nobuhiko Shizuka, Hyogo (JP); Hideaki Sakahashi, Hyogo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: NOF CORPORATION, Shibuya-ku (JP)

(21) Appl. No.: 11/411,172

(22) Filed: Apr. 25, 2006

(30) Foreign Application Priority Data
Apr. 26, 2005 (JP) 2005-127481

(51) Int. Cl. C09K 5/00

(52) U.S. Cl. 252/71

(57) ABSTRACT

The present invention provides a snow melting composition containing tripotassium citrate (a) and a non-synthetic polyhydric alcohol (b), wherein the tripotassium citrate (a) is contained in a ratio of 20 to 75 wt % and the non-synthetic polyhydric alcohol (b) is contained in a ratio of 25 to 80 wt %, with respect to the total weight of the tripotassium citrate (a) and the non-synthetic polyhydric alcohol (b). The snow melting composition of the present invention provides an excellent snow melting effect, does not corrode metals, and furthermore has low odor characteristics and thus does not adversely affect organisms living in surrounding areas.

### BACKGROUND OF THE INVENTION

1. Field of the Invention

The present invention relates to a snow melting agent to be sprinkled on the roofs and rooftops of buildings and structures, roads, and the like in residential areas or in the vicinity of residential areas. More specifically, the present invention relates to an environmentally friendly snow melting composition that provides an excellent snow melting effect and does not corrode metals, and furthermore, that has low odor characteristics and thus does not adversely affect organisms living in surrounding areas.

2. Description of the Related Art

Conventionally, various compounds, e.g., sodium chloride, calcium chloride, magnesium chloride, and alcohols, have been used to melt snow, melt ice, and prevent icy conditions on roads and the like. When sprinkled on roads and the like, these chlorine compounds and alcohols do not particularly cause a problem. However, when these chlorine compounds and alcohols are sprinkled on, for example, the roofs of buildings and structures, there is a problem in that metals, which are constituents of those roofs, are corroded by these compounds.

As a snow melting agent with improved corrosivity to metals, there is disclosed a snow melting agent containing an acetate and a water-soluble alcohol as the main components (Japanese Laid-Open Patent Publication No. 6-212147).

Although a snow melting agent containing an acetate does not corrode metals, there is a problem in that it has an odor derived from the acetate, and for this reason, it is not preferable to sprinkle such a snow melting agent in residential areas and in the vicinity of residential areas. Furthermore, this acetate and the aforementioned chlorine compounds may provide adverse effects on animals and plants, in particular, plants. That is to say, after a snow melting agent containing any of these compounds is sprinkled, plants may be withered or the growth of plants may be adversely affected.

These compounds or snow melting agents containing these compounds are suitable for sprinkling on roads, fields, and the like that are not adjacent to residential areas and where the necessity to give consideration to their adverse effects on organisms is small. However, they are unsuitable for sprinkling on buildings, structures, and the like around residential areas because of their corrosivity to metals and adverse effects on organisms.

### SUMMARY OF THE INVENTION

It is an object of the present invention to provide a snow melting composition that has an excellent snow melting effect and does not corrode metals, and furthermore, that has low odor characteristics and thus does not adversely affect organisms living in surrounding areas.

The inventors of the present invention conducted in-depth research to solve the foregoing problems and finally found that an intended snow melting composition can be obtained by combining tripotassium citrate and a non-synthetic polyhydric alcohol in a particular ratio, and thus the present invention was achieved.

A snow melting composition of the present invention comprises tripotassium citrate (a) and a non-synthetic polyhydric alcohol (b), wherein the tripotassium citrate (a) is contained in a ratio of 20 to 75 wt % and the non-synthetic polyhydric alcohol (b) is contained in a ratio of 25 to 80 wt %, with respect to the total weight of the tripotassium citrate (a) and the non-synthetic polyhydric alcohol (b).

In one embodiment, the non-synthetic polyhydric alcohol (b) is at least one selected from the group consisting of glycerin, polyglycerin, sorbitol, and erythritol.

In one embodiment, the non-synthetic polyhydric alcohol (b) is glycerin.

Furthermore, the present invention provides a snow melting system for melting snow by sprinkling the snow melting composition on the roof of a building or a structure.

Thus, the invention described herein makes possible the advantages of, providing a snow melting composition that provides an excellent snow melting effect and does not corrode metals, and furthermore, that has low odor characteristics and thus does not adversely affect organisms living in surrounding areas; and a snow melting system that is capable of melting snow evenly and uniformly.

### BRIEF DESCRIPTION OF THE DRAWINGS

FIG. 1 is a schematic diagram showing an equipment for sprinkling the snow melting composition of the present invention.

### DESCRIPTION OF THE PREFERRED EMBODIMENTS

The snow melting composition of the present invention contains tripotassium citrate (a) (hereinafter sometimes referred to as “component a”) and a non-synthetic polyhydric alcohol (b) (hereinafter sometimes referred to as “component b”) described below. In the following, these components will be successively described.

In this specification, “low odor” refers to such an odor that a person does not perceive the odor or does not mind the odor even though the person perceives it.

(I) Tripotassium Citrate

As tripotassium citrate (a) used for the snow melting composition of the present invention, both anhydrous tripotassium citrate and hydrous tripotassium citrate can be available. In the present invention, either of anhydrous and hydrous tripotassium citrates can be used, and hydrous tripotassium citrate is preferably used. As potassium citrate, there also is monopotassium citrate. However, monopotassium citrate does not have sufficient solubility in water and provide insufficient snow melting effect. Thus, it is preferable to use tripotassium citrate in the present invention.

In the present invention, the above-mentioned potassium salt is used so that the growth of plants, for example, is hardly adversely affected. Metal salts other than the potassium salt may provide adverse effects on the environment.

When the acid is a carboxylic acid other than citric acid, e.g., acetic acid, there are problems of the adverse effects on the environment and an odor as described above.

(II) Non-Synthetic Polyhydric Alcohol

The non-synthetic polyhydric alcohol (b) used for the snow melting composition of the present invention is a polyhydric alcohol, which is liquid at ordinary temperature, obtained from a natural product, e.g., a biological source. Examples of the non-synthetic polyhydric alcohol include glycerin, polyglycerin, sorbitol, and erythritol. Among these, glycerin is preferable in view of the ease of preparation of a snow melting agent, economic considerations, and the like.

(III) Snow Melting Composition

The snow melting composition of the present invention comprises tripotassium citrate (component a) and a non-synthetic polyhydric alcohol (component b), and also contains water and the like, if necessary. In this specification, “snow melting composition” refers to a mixture of the component a and the component b or the mixture further containing water and the like, and is sometimes indicated as “snow melting agent”.

Tripotassium citrate (component a) is contained in a ratio of 20 to 75 wt %, preferably 25 to 70 wt %, with respect to the total weight of the component a and the component b. When the content of the above-described component a is less than 20 wt %, freezing point of the resultant snow melting composition becomes high. When the content of the component a is more than 75 wt %, tripotassium citrate is not completely dissolved in the resultant snow melting composition and may not be dissolved uniformly.

The non-synthetic polyhydric alcohol (component h) is contained in a ratio of 25 to 80 wt %, preferably 30 to 75 wt %, with respect to the total weight of the component a and the component b. When the content of the component b is less than 25 wt %, the freezing point of the resultant snow melting composition becomes high. Furthermore, viscosity of the resultant snow melting composition becomes low, which results in poor adhesion to snow, and thus a sufficient snow melting effect may not be obtained. When the content of the component b is more than 80 wt %, flowability of the resultant snow melting composition becomes poor, and thus it may be difficult for the snow melting composition to uniformly spread over the snow. The component b may be used alone or in combination of two or more.

In the present invention, when water is used, if necessary, the type of water may be either of hard water and soft water. For example, tap water, ion exchanged water, water for industrial use, and distilled water can be used. In view of economic considerations, tap water and water for industrial use are preferable. When the snow melting composition contains water, water is contained in an amount of about 0.1 to 10 times, and preferably 0.1 to 2 times, with respect to the total weight of the component a and the component b.

The snow melting composition of the present invention is usually in the liquid state and has appropriate viscosity and wettability, so that it can be uniformly spread over a variety of types of smooth surfaces, such as the surface of a metal and the surface of a resin. Therefore, especially when sprinkled on uniform faces such as the roofs of buildings or structures, the snow melting composition of the present invention can provide an excellent snow melting effect due to the excellent spreading ability, persistence, and immediate effectivity thereof.

When snow melting agents are sprinkled on roads, golf links, tennis courts, and the like, chlorine-containing snow melting agents are often used because it is not necessary to give consideration to the corrosivity to metals. However, if these chlorine-containing snow melting agents are sprinkled on, for example, buildings or structures, then the chlorine-containing snow melting agents corrode metals, concrete, and the like, which is not preferable. On the other hand, the snow melting composition of the present invention does not corrode various metals such as iron, non-ferrous metals (aluminum, copper, etc.). Therefore, the snow melting composition of the present invention can be sprinkled, for example, on buildings or structures and in the vicinity of these without causing a problem.

The snow melting composition of the present invention has a low odor even in a form of high concentration (i.e., the total weight of the component a and the component b that are contained in the snow melting composition is 10 wt % or more), so that when sprinkled in residential areas and in the vicinity of residential areas, it does not emit a pungent odor as emitted by an acetate-containing snow melting agent. In this way, the snow melting composition of the present invention provides no adverse effect on the living environment in the vicinity where the snow melting composition is sprinkled.

Furthermore, the snow melting composition of the present invention uses tripotassium citrate, which hardly provides adverse effects on animals and plants. Therefore, the snow melting composition of the present invention does not adversely affect the ecosystem of plants and the like in a place where it is sprinkled or a place to which water from snow melted after sprinkling of the snow melting composition of the present invention flows.

(IV) Snow Melting Method and Snow Melting System

Melting of snow is conducted by sprinkling the snow melting composition of the present invention on accumulated snow surface. The snow melting composition of the present invention may be sprinkled as it is, or may be diluted with water and the like and then sprinkled when, for example, the snow melting composition has a high viscosity. When diluted for use, it is preferable to dilute the snow melting composition about 2- to 10-fold for use. Although the amount of the snow melting composition of the present invention to be sprinkled varies depending on the concentration or dilution ratio, meteorological conditions such as the temperature, the state of the surface on which the snow melting composition is to be sprinkled, and the like, it is preferable that the snow melting composition is sprinkled such that the total amount of the component a and the component b is 0.1 to 10 kg/m².

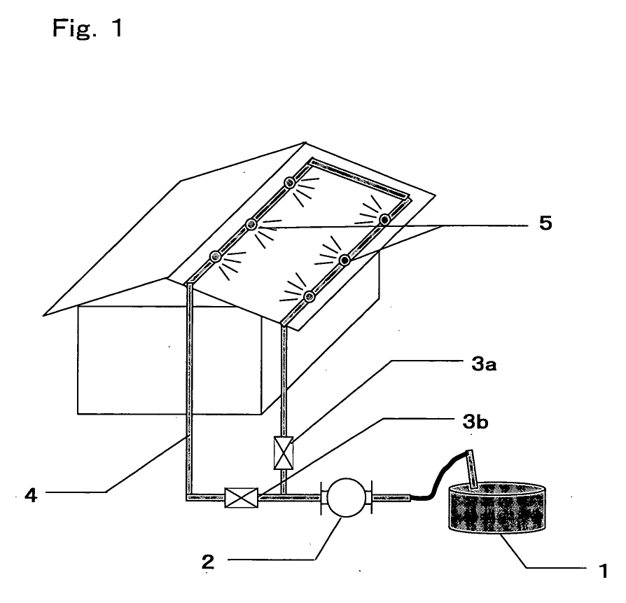

The snow melting composition of the present invention can be sprinkled to take measures against snow on the roofs and rooftops of buildings or structures, roads, and the like in residential areas or in the vicinity of residential areas. In particular, when sprinkled on the roofs of buildings or structures, the snow melting composition of the present invention provides an excellent effect. As the sprinkling method, the snow melting composition of the present invention may be sprinkled uniformly on the roofs before snow piles up, or may be sprinkled on the accumulated snow surface or in the snow after snow has piled up. FIG. 1 shows an example of the snow melting system of the present invention.

As shown in FIG. 1, when the snow melting composition is to be sprinkled on the roof of a building or a structure, a snow melting system including an undiluted snow melting agent tank 1, a liquid supply pump 2, on-off valves 3a and 3b, a transport piping 4, sprinkling nozzles 5, and others is previously installed on the building or the structure. It is preferable that the snow melting composition is sprinkled on the roof before snow piles up or sprinkled in the snow or on the accumulated snow surface after snow has piled up.

By providing the on-off valves 3a and 3b so that the inside of the piping can be pressurized, the snow melting composition is sprayed from the plurality of sprinkling nozzles 5 uniformly. Therefore, with the snow melting system of the present invention, melting of snow can be effected evenly and uniformly.

When sprinkling the snow melting composition, it is preferable to adjust the number of nozzles from which the composition is sprinkled, the shape of the nozzles, the amount of the snow melting composition to be sprinkled, and the like as appropriate. When the snow melting composition is sprinkled on smooth surfaces such as accumulated snow surface, roofs, and the like, various types of nozzles can be used. For example, a flat spray nozzle, a quick installation nozzle, an even flat spray nozzle, a descaling nozzle, an off-center even flat spray nozzle, an air mixing type flat spray nozzle, a full cone spray nozzle, a square full cone spray nozzle, a solid stream jet nozzle, a trimming nozzle, and a hollow cone spray nozzle can be used preferably. Among these nozzles, a flat spray nozzle and a full cone spray nozzle are used more preferably.

### EXAMPLES

Next, the present invention will be described in greater detail by way of examples.

### Example 1

As shown in Table 1, 15 wt % of tripotassium citrate, 60 wt % of glycerin, and 25 wt % of tap water were mixed to prepare a snow melting agent 1.

### Examples 2 to 4

As in Example 1, components shown in Table 1 were mixed in amounts shown in Table 1 to prepare snow melting agents (snow melting agents 2 to 4).

### Comparative Examples 1 to 6

As in Example 1, components shown in Table 1 were mixed in amounts shown in Table 1 to prepare snow melting agents (snow melting agents 5 to 10).

Table 1 shows the state of each of the obtained snow melting agents 1 to 10.

TABLE 1

| | | Example | | | | Comparative Example | | | | | |
|---|---|---|---|---|---|---|---|---|---|---|---|
| | | 1 | 2 | 3 | 4 | 1 | 2 | 3 | 4 | 5 | 6 |
| | | Snow | Snow | Snow | Snow | Snow | Snow | Snow | Snow | Snow | Snow |
| | | melting | melting | melting | melting | melting | melting | melting | melting | melting | melting |
| | | agent 1 | agent 2 | agent 3 | agent 4 | agent 5 | agent 6 | agent 7 | agent 8 | agent 9 | agent 10 |
| a | Tripotassium citrate | 15 | 30 | 50 | 20 | — | — | — | — | — | — |
| | (wt %) | | | | | | | | | | |
| Potassium acetate (wt %) | | — | — | — | — | 27 | 30 | — | — | — | — |
| Calcium chloride (wt %) | | — | — | — | — | — | — | 40 | — | — | — |
| Sodium chloride (wt %) | | — | — | — | — | — | — | — | 20 | — | — |
| Trisodium citrate (wt %) | | — | — | — | — | — | — | — | — | — | 30 |
| Calcium citrate (wt %) | | — | — | — | — | — | — | — | — | 16 | — |
| b | Glycerin (wt %) | 60 | 40 | 20 | — | 13 | 40 | — | — | — | 40 |
| | Sorbitol (wt %) | — | — | — | 40 | — | — | — | — | — | — |

| | | | | | | | | | | |
|---|---|---|---|---|---|---|---|---|---|---|
| (a/(a + b)) × 100 (%) | (20) | (42.9) | (71.4) | (33.3) | — | — | — | — | — | — |
| (b/(a + b)) × 100 (%) | (80) | (57.1) | (28.6) | (66.7) | — | — | — | — | — | — |
| Ethylene glycol (wt %) | — | — | — | — | — | — | — | — | 16 | — |
| Water (wt %) | 25 | 30 | 30 | 40 | 60 | 30 | 60 | 80 | 67 | 30 |
| Total | 100 | 100 | 100 | 100 | 100 | 100 | 100 | 100 | 100 | 100 |
| State of snow melting | Uniform | Uniform | Uniform | Uniform | Uniform | Uniform | Uniform | Uniform | Salt was not | Uniform |
| agent after preparation | and | and | and | and | and | and | and | and | dissolved | and |
| | trans- | trans- | trans- | trans- | trans- | trans- | trans- | trans- | | trans- |
| | parent | parent | parent | parent | parent | parent | parent | parent | | parent |

As shown in Table 1, the snow melting agents 1 to 8 and snow melting agent 10 were uniformly transparent liquids. However, in the snow melting agent 9, the salt used (i.e., calcium citrate) remained undissolved.

Then, regarding the uniformly transparent snow melting agents 1 to 8 and snow melting agent 10, (1) a measurement of the freezing point, (2) an odor assessment, and (3) a metal corrosivity test were conducted. Furthermore, (4) a plant growth test was conducted using the snow melting agents 2, 6, 7, and 10.

(1) Measurement of Freezing Point

The freezing points of the snow melting agents 1 to 8 and snow melting agent 10 were measured according to the method of JAOCS 2. 3. 5. 2-71 freezing point (Shukoff method). Table 2 shows the results.

(2) Odor Assessment

Regarding the snow melting agents 1 to 8 and snow melting agent 10, diluted solutions obtained by diluting each of these snow melting agents with an amount of water that is twice the weight of the snow melting agent, and diluted solutions obtained by diluting each of these snow melting agents with an amount of water that is ten times the weight of the snow melting agent, five panelists were subjected to an odor assessment. Evaluations were made as described below. Table 2 shows the results.

◯: None perceived an odor.

Δ: One to three perceived an odor.

×: Four or more perceived an odor.

(3) Metal Corrosivity Test

Test pieces of a steel plate (SPCC), an aluminum plate, and a copper plate were each polished with a grinder, degreased, and dried. Then, each of the test pieces was fully immersed in the snow melting agents 1 to 8 and snow melting agent 10, and thereafter held such that ½ of the height of the test piece from its bottom end was immersed therein, and the occurrence of corrosion after three days was observed visually. The test was conducted at room temperature. Then, for each test piece, evaluations were made as described below. Table 2 shows the results.

◯: No change occurred.

Δ: Rust and color change were observed to some extent.

×: Significant rust and color change were observed.

TABLE 2

| | | Example | | | | Comparative Example | | | | |
|---|---|---|---|---|---|---|---|---|---|---|
| | | 1 | 2 | 3 | 4 | 1 | 2 | 3 | 4 | 6 |
| | | Snow | Snow | Snow | Snow | Snow | Snow | Snow | Snow | Snow |
| | | melting | melting | melting | melting | melting | melting | melting | melting | melting |
| | | agent 1 | agent 2 | agent 3 | agent 4 | agent 5 | agent 6 | agent 7 | agent 8 | agent 10 |
| Freezing point (° C.) | | −55 or less | −26.6 | −55 or less | −42 | −33 | −55 or less | −54.8 | −17.5 | −55 or less |
| Odor | No dilution | ◯ | ◯ | ◯ | ◯ | X | X | ◯ | ◯ | ◯ |
| assessment | 2-fold diluted | ◯ | ◯ | ◯ | ◯ | X | X | ◯ | ◯ | ◯ |
| | solution | | | | | | | | | |
| | 10-fold diluted | ◯ | ◯ | ◯ | ◯ | X | X | ◯ | ◯ | ◯ |
| | solution | | | | | | | | | |
| Metal | Steel plate | ◯ | ◯ | ◯ | ◯ | ◯ | ◯ | X | X | ◯ |
| corrosivity | Aluminum | ◯ | ◯ | ◯ | ◯ | ◯ | ◯ | Δ | Δ | ◯ |
| | plate | | | | | | | | | |
| | Copper plate | ◯ | ◯ | ◯ | ◯ | ◯ | ◯ | X | X | ◯ |

From the results in Table 2, the snow melting agents 1 to 4 of the present invention were excellent in terms of odor prevention and non-corrosivity to various metals.

On the other hand, the snow melting agents 5 and 6 containing potassium acetate were found to be unsuitable for sprinkling in residential areas and the like because those snow melting agents had an odor. The snow melting agent 7 containing calcium chloride and the snow melting agent 8 containing sodium chloride were found to be unsuitable for direct sprinkling on buildings or structures because those snow melting agents were corrosive to metals.

(4) Plant Growth Test (Growth Test of White Radish Sprout)

A growth test of a plant (white radish sprout) was conducted in the following manner using the snow melting agents 2, 6, 7, and 10.

The snow melting agents 2, 6, and 10 were each diluted 50-fold by weight with water to prepare diluted solutions (concentration of the total of the component a and the component b was 1.4 wt %). As for the snow melting agent 7, a diluted solution was prepared such that the concentration of its component is equal to the concentration of the total of the component a and the component b in each of the diluted solutions of the snow melting agents 2, 6, and 10. Namely, the snow melting agent 7 was diluted 28.6-fold by weight with water to prepare a diluted solution having a calcium chloride concentration of 1.4 wt %.

Then, a filter paper was dipped in the diluted solutions thus prepared. The filter paper dipped was placed in a petri dish, and several white radish seeds were put on the filter paper. The petri dish was covered with a lid, allowed to stand in a sunny place for one week, and the conditions of germination were observed. The conditions of germinated plant after one week were evaluated as described below. Table 3 shows the results.

◯: No adverse effect on the plant was confirmed.

Δ: The plant was adversely affected to some extent.

×: The plant was adversely affected significantly.

TABLE 3

| | Example 2 | Comparative Example 2 | Comparative Example 3 | Comparative Example 6 |
|---|---|---|---|---|
| Test solution | 50-fold diluted solution of | 50-fold diluted solution of | 28.6-fold diluted solution of | 50-fold diluted solution of |
| | snow melting agent 2 | snow melting agent 6 | snow melting agent 7 | snow melting agent 10 |
| | (Active component: | (Active component: | (Active component: | (Active component: |
| | 1.4 wt %) | 1.4 wt %) | 1.4 wt %) | 1.4 wt %) |
| Day 3 after the | Germination was observed. | No germination was | Germination was observed. | No germination was |
| start of the test | | observed. | | observed. |
| Day 7 after the | The shoots were growing | Some of the seeds had | The shoots were growing, | Some of the seeds had |
| start of the test | well. | germinated, but were | but were withering at the | germinated, but were |
| | | withering at the top. | top. | withering at the top. |
| Evaluation | ◯ | X | Δ | X |

From the results in Table 3, the snow melting agent 2 of the present invention did not adversely affect the growth of the plant (white radish sprout).

On the other hand, it was found that the snow melting agent 6 containing potassium acetate, the snow melting agent 7 containing calcium chloride, and the snow melting agent 10 containing trisodium citrate provided adverse effects on the growth of the plant (white radish sprout).

The snow melting agent of the present invention provides an excellent snow melting effect, does not corrode metals, and furthermore has low odor characteristics and thus does not adversely affect organisms living in surrounding areas. Therefore, it can be used as a snow melting agent to be sprinkled especially on the roofs and the like of buildings and structures. Therefore, for example, the labor required for removing snow from roofs on other places, as well as the hazards accompanied by those works can be avoided.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A snow melting composition containing tripotassium citrate (a) and a non-synthetic polyhydric alcohol (b),
wherein the tripotassium citrate (a) is contained in a ratio of 20 to 75 wt % and the non-synthetic polyhydric alcohol (b) is contained in a ratio of 25 to 80 wt %, with respect to the total weight of the tripotassium citrate (a) and the non-synthetic polyhydric alcohol (b).

2. The snow melting composition of claim 1, wherein the non-synthetic polyhydric alcohol (b) is selected from the group consisting of glycerin, polyglycerin, sorbitol, and erythritol.

3. The snow melting composition of claim 2, wherein the non-synthetic polyhydric alcohol (b) is glycerin.

4. A snow melting system for melting snow by sprinkling the snow melting composition of claim 1 on the roof of a building or a structure.
